(19) United States
(12) Patent Application Publication
(10) Pub. No.: US 2016/0115675 A1
(43) Pub. Date: Apr. 28, 2016

(54) METHOD FOR AUTOMATED CONTROL OF A COMBINED GREYWATER/STORMWATER SYSTEM WITH FORECAST INTEGRATION

(71) Applicants: Marcus Quigley, Brookline, MA (US); Brian Halaburka, Stanford, CA (US); Richard G. Luthy, Stanford, CA (US); David Sedlak, Berkeley, CA (US)

(72) Inventors: Marcus Quigley, Brookline, MA (US); Brian Halaburka, Stanford, CA (US); Richard G. Luthy, Stanford, CA (US); David Sedlak, Berkeley, CA (US)

(21) Appl. No.: 14/924,247

(22) Filed: Oct. 27, 2015

Related U.S. Application Data
(60) Provisional application No. 62/069,604, filed on Oct. 28, 2014.

(51) Int. Cl. E03B 1/04; G05B 13/02

(52) U.S. Cl. CPC E03B 1/042; G05B 13/026; E03B 2001/047

(57) ABSTRACT

A forecast-integrated automated control system for combined greywater-stormwater storage and reuse. A simple and reliable approach for managing greywater and stormwater collection at a household or community level is provided, allowing for the near-continuous monitoring and adjustment of water quantity and quality in a combined greywater-stormwater storage tank based on monitored feedback/output from individual, tank-specific sensors and/or sensors located elsewhere in the water collection system. Use of the forecast-integrated automated control system for combined greywater-stormwater storage and reuse enables optimization of the water quality and quantity collected in the storage tank, reduce the amount of stormwater discharged to municipal sewers, and assure/demonstrate regulatory compliance for control of stormwater runoff through the integration of a low impact development best management practices.

### STATEMENT REGARDING FEDERALLY SPONSORED RESEARCH OR DEVELOPMENT

n/a

### BACKGROUND OF THE INVENTION

Water is a scarce resource in the arid West of the United States, and recent droughts in the Midwest and the South have elevated the issue of water scarcity to a national level. Existing water sources will face increasing strain due to population growth and climate change, and financial and regulatory barriers will prevent the development of new sources. One method to alleviate water scarcity is stormwater capture. Stormwater can be used for non-potable applications such as irrigation, laundry, and toilet flushing to significantly reduce domestic municipal water consumption. However, in arid regions of the US, rain comes in short, intense storms only a few months out of the year, and the duration and intensity of these storms require large storage tank volumes for stormwater capture to be financially feasible. One solution is to integrate stormwater capture with greywater capture. Greywater is a reliable source of water for domestic reuse, and includes water from washbasins, laundry, and showers (kitchen sinks and water for toilet flushing are considered blackwater). Combining greywater-stormwater in the same collection system allows for a much smaller storage tank.

FIG. 1 shows a schematic of a typical combined greywater-stormwater storage system for domestic use 10. These systems capture stormwater runoff 12 from building roofs 34 and other impervious surfaces 36 such as parking lots and greywater from washbasins 14, laundry machines 16, and showers 18 and store the collected water in the same storage tank 20, typically installed under the house, outside, or underground. Other systems route the captured stormwater directly to a combined or separate storm sewer 22. Many of these systems include some sort of treatment process 24 for the greywater prior to storage, such as filtration or disinfection. Water stored in the tank 20 can then be used for toilets 28, irrigation or other domestic non-potable uses 26. An overflow pipe 30 at the top of the storage tank allows excess stormwater or greywater to overflow to a municipal sewerage system 32 or onsite wastewater treatment system (not shown).

Unfortunately, a number of problems exist with currently available combined stormwater-greywater storage systems. One of the major drawbacks of greywater storage is that water quality in the tank degrades quickly after prolonged storage. Potable water 40 may be used to dilute the greywater, but this is not a desirable use of a limited resource. Although a combined stormwater-greywater system can alleviate this problem by diluting greywater 42 with higher quality stormwater 12, the currently available systems are unable to predict when rainfall events will occur in order to empty the tank 20 of old, poor quality water to make room for new water. As a result, many impurities remain in the tank even after rainfall events.

A secondary purpose of stormwater capture may be to reduce the intensity and duration of stormwater flow into the municipal sewer system and receiving waters. Heavy rainfall leads to a dramatic increase in the volume of wastewater sent to wastewater treatment plants in combined sewer areas, and these increases can overwhelm the capacity of the plant and lead to the unintended discharge of raw sewage to natural water bodies. Current combined greywater-stormwater systems are unable to regulate the volume of water entering sanitary sewers because they may be filled to capacity at the time of a storm.

Lastly, new infrastructure projects are required to implement Best Management Practices (BMPs) for low impact development in many states throughout the United States. These BMPs often require new developments to entrain 85% of stormwater runoff generated from a newly developed site. Although current combined greywater-stormwater storage systems capture rainfall, they cannot be relied upon to prevent stormwater from entering sewers and therefore do not meet low impact development requirements for new infrastructure. Most critically, existing systems do not utilize digital weather forecasting information in order to anticipate the likely volume of future precipitation, e.g., rain or snowmelt, that may be added to the storage tank during a current or future precipitation event and act on this information to manipulate the volume maintained in the storage tank.

### BRIEF SUMMARY OF THE INVENTION

The problems with current combined greywater-stormwater capture and reuse systems identified above can be addressed using a forecast-integrated automated control system for combined greywater-stormwater storage and reuse, as described herein.

The presently disclosed system and method provide a simple and reliable approach for managing greywater and stormwater collection at a household or community level, and allows for the near-continuous monitoring and adjustment of water quantity and quality in a combined greywater-stormwater storage tank based on monitored feedback/output from individual, tank-specific sensors and/or sensors located elsewhere in the water collection system. Use of the forecast-integrated automated control system for combined greywater-stormwater storage and reuse allows an owner, operator, or technician to optimize the water quality and quantity collected in the storage tank, reduce the amount of stormwater discharged to municipal sewers, and assure/demonstrate regulatory compliance for control of stormwater runoff through the integration of a low impact development BMP.

The invention pertains to a forecast-integrated automated control system for combined greywater-stormwater capture and reuse. The system is comprised of six primary components that together provide an efficient and robust solution to the complex optimization of combined greywater-stormwater storage: a combined greywater-stormwater storage tank; greywater and stormwater collection systems; a stormwater runoff bypass system; a greywater bypass system; a tank drawdown valve or pump system; and a forecast-integrated control system.

A discussion of these six individual components is presented below, followed by a description of the fully integrated system and methods implemented therewith.

### BRIEF DESCRIPTION OF THE SEVERAL VIEWS OF THE DRAWINGS

Embodiments of the present invention may be better understood by referring to the following description in conjunction with the accompanying drawings in which:

FIG. 1 is a block diagram illustrating the state of the art in discrete greywater and stormwater systems;

FIG. 2 is a block diagram illustrating a combined greywater/stormwater system with forecast-integrated control, as disclosed herein;

FIG. 3 is a schematic illustration of connections provided to a controller of the system of FIG. 2;

FIG. 4 is a flowchart depicting basic operations of the method implemented by the combined greywater/stormwater system with forecast-integrated control;

FIG. 5 is a flowchart depicting a storage tank drawdown subroutine of the method of FIG. 4;

FIG. 6 is a flowchart depicting a storage tank water quality monitoring subroutine of the method of FIG. 4; and

FIG. 7 is a flowchart depicting a greywater management subroutine of the method of FIG. 4.

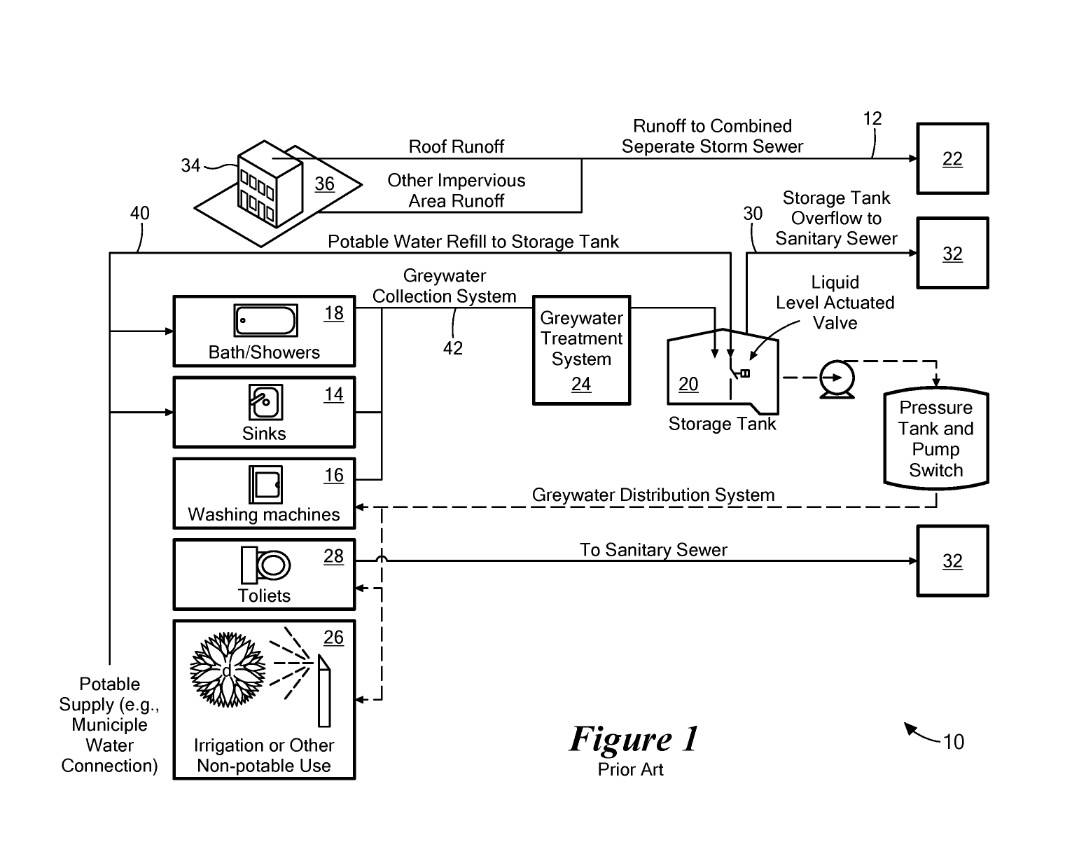

### DETAILED DESCRIPTION OF THE INVENTION

This application claims priority of U.S. Prov. Pat. Appl. No. 62/069,604, filed Oct. 28, 2015, which is incorporated herein in its entirety.

Disclosed is a forecast-integrated automated control system 102 for combined greywater-stormwater capture and reuse, a combined greywater-stormwater capture and re-use system 100 incorporating such a control system, and methods of use implemented by the controller and the combined system. The combined system is comprised of six primary functional components: a combined greywater-stormwater storage tank 120; greywater and stormwater collection systems 142, 112; a stormwater runoff bypass system 150; a greywater bypass system 152; a storage tank drawdown valve 154 and/or pump system 156; and the forecast-integrated control system 102, the latter also being referred to simply as the controller. Each of these components is discussed separately herein, followed by a description of the integrated system and methods.

The storage tank 120 is a tank, or functionally similar storage volume, intended to store both stormwater runoff 112 and greywater 142. Stormwater runoff is typically collected from building roofs 134 and other impervious surfaces 136 such as parking lots. The tank preferably has two separate inlets: one for the greywater collection system 142 and one for the stormwater collection system 112. The tank is of conventional construction and is sized according to the predicted requirements of the respective installation, taking into consideration factors such as historical stormwater and/or greywater volumes as a factor of time, predicted trends in such volumes resulting from factors such as climate change, re-use requirements/opportunities, available space, and the ability of an interconnected storm and/or sanitary sewer to absorb bypass volumes from the integrated system. An overflow pipe 130 at or near the top of the tank allows excess water to flow from the tank into the municipal sewer 132 when the tank maximum capacity is reached. Inputs from one or more sensing devices 160 are employed by the controller to estimate the volume of combined greywater and stormwater within the storage tank. The controller is then capable of controlling the operating status of one or more controllable water pumps, drain valves, and/or auxiliary bypass discharge valves, discussed subsequently. Exemplary sensing devices are discussed below.

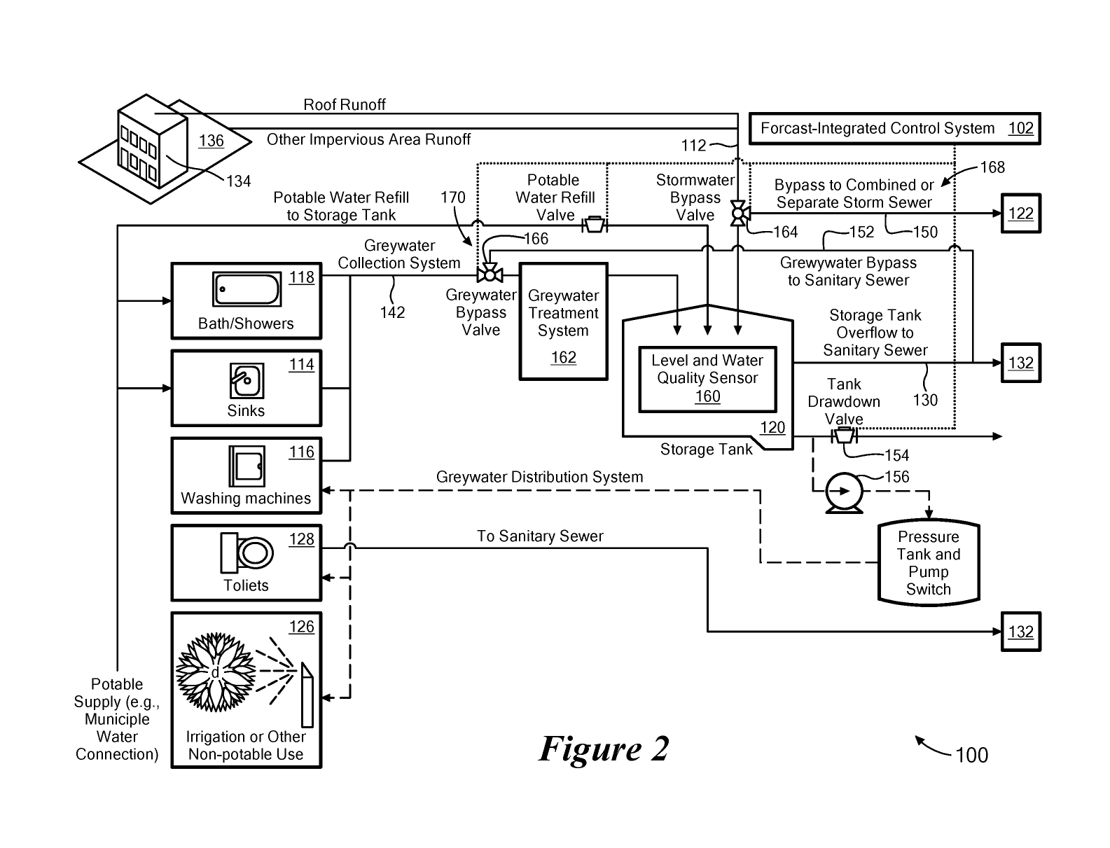

The greywater and stormwater collection systems 142, 112 are drainage and/or plumbing systems of contemporary construction that connect greywater and stormwater runoff, respectively, to the storage tank 120. The greywater and/or stormwater collection systems optionally include a treatment step, e.g. filtration, by a respective treatment system prior to storage. In FIG. 2, a greywater treatment system 162 is illustrated. While not shown, a similar treatment system can be disposed between a stormwater runoff bypass valve 164 and the storage tank, or after a stormwater runoff bypass valve 164, in a respective bypass flow path 150. A bypass system 170, 168 within each collection system 142, 112, discussed below, allows the greywater and/or stormwater to flow directly to the tank, to a treatment process 162, and/or to a municipal sanitary or storm sewer 132, 122, depending on the water level in the system storage tank and predicted volumes of greywater and/or stormwater to be received in a future time interval.

The stormwater runoff bypass system 170 includes an active or passive bypass flow path 150 configured to enable the selective diversion of stormwater runoff directly to a storm sewer 122 or on-site stormwater treatment system (not illustrated) instead of to the storage tank 120. The controller 102 manages the operation of a respective drain valve 164 of the bypass system leading to the stormwater runoff bypass flow path 150, taking into consideration factors such as sensor 160 input(s) indicative of storage tank water level and storage tank water quality parameters, and weather forecasts predicting the volume of water that may enter the tank over a given time period. Other information that the controller may take into consideration in the selective operation of the stormwater runoff bypass valve includes Hydromodification Management (HM) Best Management Practices (BMPs) for an associated stormwater runoff system. The constituent valve is an automatic, remote controlled valve of conventional construction.

The greywater bypass system 170 is an active or passive bypass flow path 152 configured to enable the selective diversion of greywater directly to a sanitary sewer 132 instead of to the storage tank 120. Similar to the stormwater runoff bypass system 168 described above, the controller 102 manages the operation of the respective greywater bypass drain valve 166 leading to the greywater bypass flow path 152, taking into consideration factors such as sensor 160 input(s) indicative of storage tank water level and storage tank water quality parameters, weather forecasts predicting the volume of water that may enter the tank over a given time period, and predicted or actual indications of available capacity of an associated sewage treatment system fed by the respective sanitary sewer. Greywater may be diverted away from the storage tank if the tank is already full or if the controller predicts a large storm is coming.

The configuration of each of the greywater bypass system 170 and the stormwater runoff bypass system 168 by the controller 102 may be handled discretely or may be handled in a coordinated fashion. For example, if feedback indications received by the controller suggest the HM BMP for a given runoff system would be exceeded if additional stormwater runoff were to be routed through the respective bypass system, the stormwater runoff bypass valve 164 is configured to route stormwater to the storage tank while the greywater bypass system 170 is actuated instead if one or more sensors 160 provide indications to the controller that available storage tank 120 capacity is insufficient for receiving both stormwater runoff and greywater inflows.

Further, the controller 102 is able to respond to changing conditions over time. Thus, while sufficient storage tank 120 capacity may exist at the onset of a precipitation event, if conditions change from a prediction model, one or both bypass systems 170, 168 may be enabled to prevent over-filling the storage tank.

The storage tank drawdown valve 154 and/or pump system 156 is a selectively operable system for controlling the water level in the storage tank 120 by discharging stored water (i.e., combined greywater and stormwater) from the storage tank to the sanitary sewer 132 (or a combined sanitary/stormwater sewer) or to an acceptable on-site use, such as washing machines 116, toilets 128, irrigation, decorative fountains, or other non-potable use 126. The storage tank drawdown valve 154 is of conventional construction. The drawdown pump system 156 in one embodiment comprises a conventional pump and associated pressure tank with pump switch. Both the drawdown valve 154 and pump system 156 are remotely and automatically operated by the controller 102, based on water quantity and quality in the tank, weather forecasts, and other optional inputs that can include associated sewer treatment facility available capacity, HM BMPs, etc. The controller may be programmed to estimate the timing and volume of non-potable water demand or available capacity, such as for landscape irrigation, based upon pre-programmed predictions and/or calculated from historic use data recorded by the controller or otherwise provided to it, and to optimize the balance between creating room for greywater and/or stormwater runoff capture in the storage tank and maintaining supply for non-potable reuse. The drawdown valve may discharge to the municipal sanitary sewer if the controller determines there is a need to make room for incoming stormwater runoff, or it may supply stored water for domestic non-potable reuse. The controller is designed to efficiently capture, transmit, and store water quantity and quality sensor information associated with the storage tank, process and analyze these data, evaluate attainment of optimization goals, and ultimately transmit signals to control/adjust the storage tank drawdown valve and/or pump system.

The forecast-integrated control system 102 in one embodiment is a controller and all related hardware and software for actuating the storage tank drawdown valve 154 and/or pump system 156, the greywater bypass system 170, and the stormwater runoff bypass system 168. The control system may be comprised of a field Internet Gateway Device (IGD) or Devices (IGDs) that include microcontrollers and Internet Protocol (IP)-based communications hardware and software interfaces that facilitate bi-directional communication with internet-based web services (e.g., cloud-based control systems and Application Programming Interfaces (APIs)). Other physical configurations are envisioned and employable.

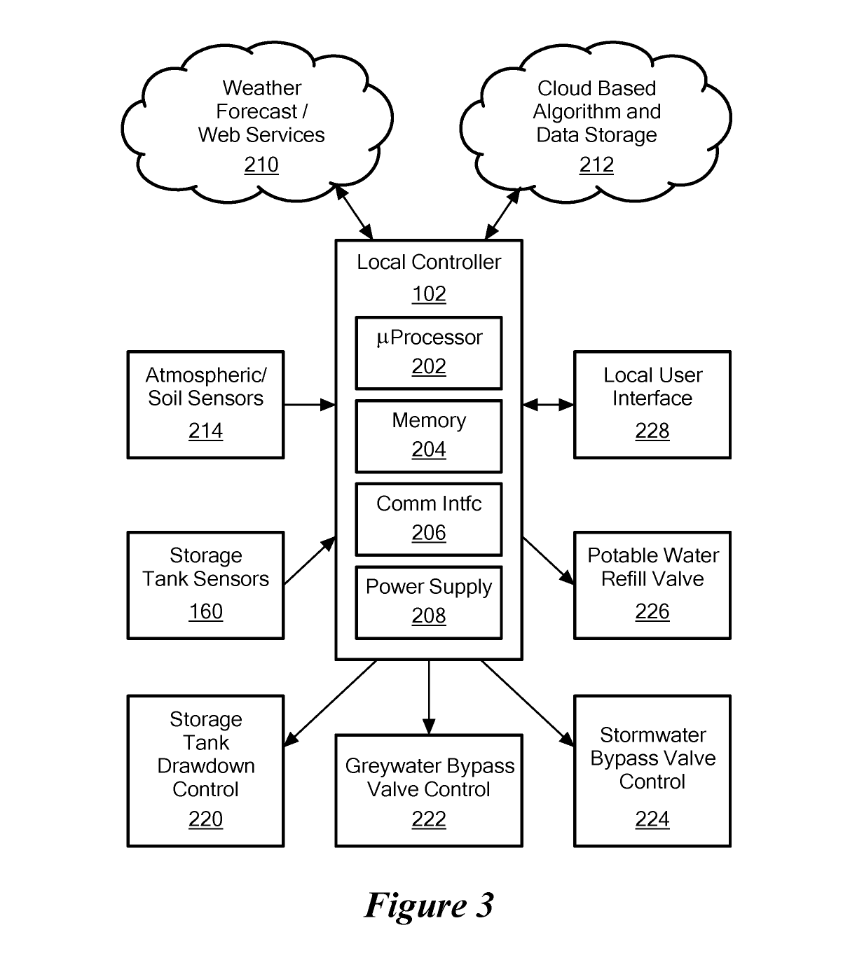

A block diagram illustrating the control system 102 and the network of communications pathways to which it interfaces is shown in FIG. 3. A controller IGD is comprised of a microprocessor 202, local memory 204, communications interfaces 206, and a power supply 208, the latter being an interface to an external power source and/or internal battery power. The communications interfaces enable a data pathway to and from the internet-based web services and weather forecasts 210 and cloud-based algorithm and data storage 212. In addition to the sensors 160 associated with the storage tank 120, described in greater detail herein, other sensors 214 may be employed for providing data to the controller, such as atmospheric or soil temperature, humidity and pressure sensors. Control applications, as previously described, include storage tank drawdown control 220, greywater bypass valve control 222, stormwater bypass valve control 224, and potable water refill valve control 226. Additionally, a local interface 228 may be provided to enable local control, reconfiguration, programming and data readout of the controller.

By means of site-specific algorithms made available to the controller 102 via internet-based web services, the control system is able to integrate weather forecast information into the control logic running locally on the controller in order to make available adequate storage volume in the storage tank 120 needed to effectively control stormwater runoff or achieve some similar site specific water control objective (e.g., reduce environmental impacts of the system, conserve water, etc.) The forecast-integrated control system predicts an expected time-dependent volume of water being added to or to be added to the system as well as a prediction of onsite water use and/or capacity for use, and the controller operates the storage tank drawdown valve 154 and/or pump system 156 to draw down the tank and/or activate at least one of the greywater and stormwater runoff bypass valves 166, 164 to divert either greywater or stormwater away from the storage tank to provide adequate storage volume for the predicted precipitation. Preferably, the precipitation forecast device or service provides weather precipitation data from an internet-connected resource source 210 such as the World Wide Web, internet-based web services, a local area network (LAN), a wide area network (WAN), and/or a dedicated weather data server or web service.

The site-specific algorithms may be individually coded for each location, or may take the form of a template into which various site-specific input data are loaded. Such input data may include storage tank 120 maximum capacity, the identification of sensors associated with the storage tank 160, greywater collection system (not shown), stormwater runoff collection system (not shown), soil or atmospheric hygrometers, thermometers, atmospheric barometers 214, etc., data relating to HM BMPs for an associated runoff system, and inputs from an associated sanitary sewer 132, storm sewer 122 and/or downstream sewage treatment facility (not shown) as to free capacity. Further, such algorithms may have baseline storage tank profiles that control storage tank capacity based upon factors such as historic environmental data, subject to modification based upon forecast data received by the controller. For example, a location may typically experience, on a year-to-year basis, very little precipitation for nine months of the year. During those months, the controller, executing the respective algorithm, provides less capacity for stormwater runoff unless a newly received forecast indicates more stormwater may be received. However, during the other three months of the calendar year, rain storms are more frequent and so the storage tank is configured to receive more stormwater runoff in the absence of forecast data, and subject to modification by newly received forecast data.

The site-specific algorithms can also be customized to take into consideration, in addition to the other inputs discussed above, the storage tank 120 water quality and possible need for purging and refilling to address contents of increasing turbidity and stagnation. Sensors associated with the storage tank 160 and providing input to the controller 102 can include temperature, turbidity, conductivity, oxidation reduction potential, nitrate concentration, etc. Such sensor data may also be used by the controller in determining the suitability of the storage tank contents for local non-potable use, such as irrigation.

The controller algorithm may also enable the prediction of a number of water quality parameters (e.g., biological oxygen demand, fecal coliform concentration, total suspended solids, and dissolved oxygen levels) based upon one or more of how much stormwater runoff has entered the tank in a given time period versus how much greywater has entered the tank in the same time period, the recycle rate of the water, and easy to measure surrogate parameters like temperature and conductivity.

Additionally the controller algorithm is capable of responding to pre-programmed predictions of greywater production based on previous use patterns; as water is added to the tank over time, the controller uses machine learning processes to estimate how much greywater to expect and integrates this with the weather forecast for more accurate predictions of required storage capacity. Alternatively, such greywater production predictions are factored into the respective algorithm prior to being programmed into the respective controller.

The integration of the six primary functional components of the forecast-integrated greywater-stormwater capture and reuse system 100, individually described above, is shown schematically in FIG. 2.

Initially, the stormwater running off from roofs and impervious surfaces 134, 136 and greywater from washbasins 114, showers 118, and laundry machines 116 is plumbed to the combined greywater-stormwater storage tank 120 that fills until a defined level is reached. The controller monitors water level and water quality parameters within the storage tank via plural sensors 160 disposed in conjunction with the storage tank. As the water level reaches maximum capacity for the storage tank or some other predefined level below that threshold, the controller either i) diverts incoming greywater to the sanitary sewer 132 by actuation of the greywater bypass valve 166, ii) actuates the storage tank drawdown valve 154 to direct stored water to the sanitary sewer, or iii) actuates the drawdown pump system 156 to drain stored water from the storage tank and to direct it for non-potable use. The controller may be programmed to supply stored water for re-use applications at regular times and volumes, and it may ensure that adequate water quantity and quality is available for the re-use application from data gathered by sensors within the tank.

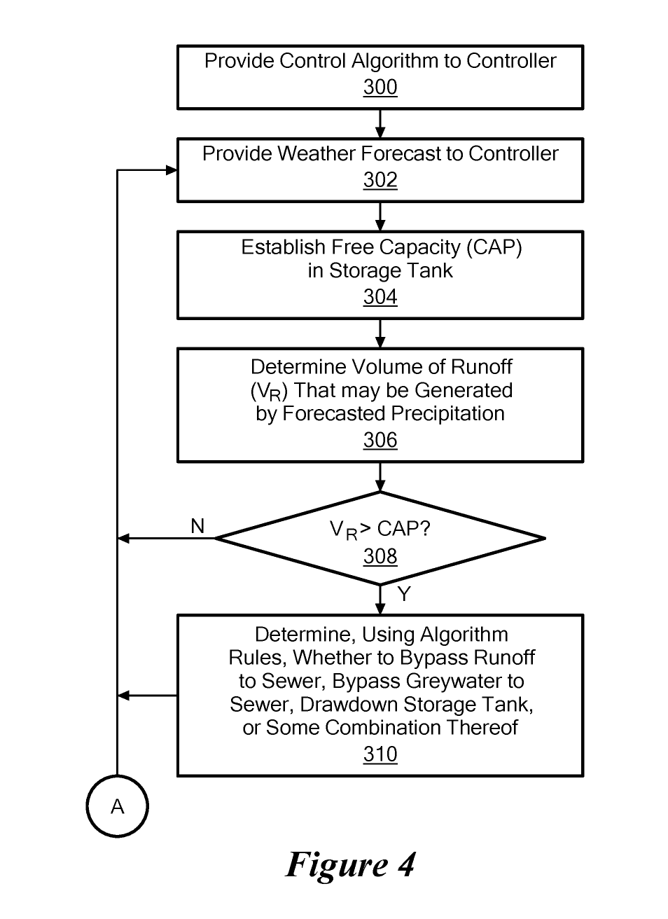

A basic method of operation is described with reference to FIG. 4. Initially, the controller 102 is provided with an algorithm 300 for implementing the combined greywater/stormwater control system with forecast integration. The controller is connected to a precipitation forecast source 302 and, using tank-located sensors 160, establishes the free capacity within the storage tank 304. In the event a storm is predicted, the controller determines the expected volume of stormwater runoff that may be produced 306. The controller then compares the free capacity to the runoff prediction 308. If the expected volume is greater than the free capacity within the tank, the controller determines 310, on the basis of the algorithm, whether to actuate the stormwater runoff bypass valve 164, actuate the greywater bypass valve 166, actuate the storage tank drawdown valve 154, actuate the drawdown pump system 156 to drain the storage tank 120, or some combination thereof.

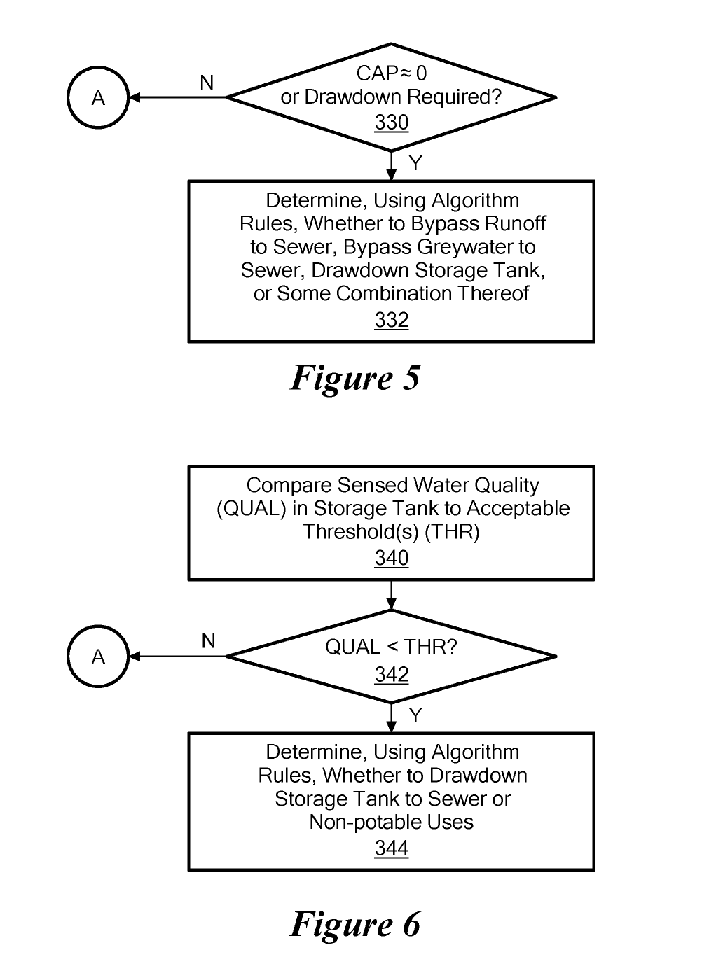

In FIG. 5, a further sub-routine of the algorithm, executed by the controller 102, determines if the free capacity of the storage tank 120 is substantially zero or whether drawdown is otherwise required 330, such as due to predicted rainfall and/or predicted greywater inflow. If so, the controller, executing the algorithm, determines 332 whether to actuate the stormwater runoff bypass system 168, actuate the greywater bypass system 170, actuate the tank drawdown valve 154, actuate the drawdown pump system 156, or some combination thereof.

In FIG. 6, a further sub-routine of the algorithm, executed by the controller 102, compares data from sensors 160 disposed in conjunction with the storage tank 120 to acceptable water quality thresholds 340. As previously discussed, such measures may include temperature, turbidity, conductivity, oxidation reduction potential, nitrate concentration, etc. If the stored water quality is determined to be below acceptable levels 342, the controller uses the algorithm to determine 344 whether to drawdown the storage tank to the respective sanitary sewer 132 via actuation of the drawdown valve 154 or to non-potable uses via actuation of the drawdown pump system 156.

Water quality parameter levels may be set on the controller so that when these values are exceeded, the controller drains the tank to flush out the poor quality water. The levels may be based on state/municipal-level regulatory limits for greywater reuse.

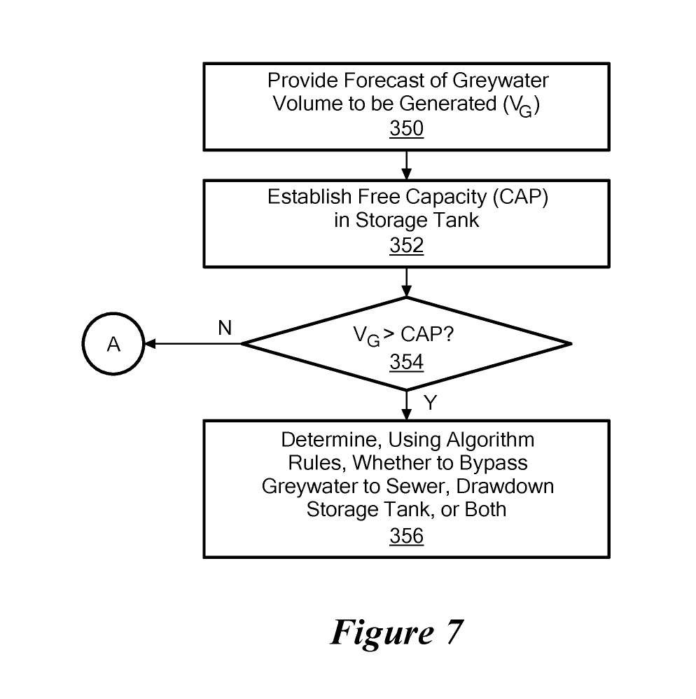

In FIG. 7, a further sub-routine of the algorithm, executed by the controller 102, includes providing the controller with a forecast of a volume of greywater to be expected 350, such as based on historical analysis. The controller establishes 352 the free capacity of the storage tank 120 on the basis of input from tank-mounted sensors 160 and a predetermined acceptable water level within the storage tank. Then, the controller compares 354 the expected volume of greywater to the free capacity within the tank. If the expected volume of greywater exceeds the free capacity, the controller then determines 356 whether to actuate the greywater bypass system 170, drawdown the storage tank to the respective sanitary sewer 132 via actuation of the drawdown valve 154 or to non-potable uses via actuation of the drawdown pump system 156, or some combination thereof.

Information collected by the controller is processed and various reports, plots, notifications, and visual representations are automatically generated and available to the homeowner/operator via web connected cloud-based web dashboards 210 or the local user interface 228.

Various operations described are purely exemplary and imply no particular order. Further, the operations can be used in any sequence when appropriate and can be partially used. With the above embodiments in mind, it should be understood that additional embodiments can employ various computer-implemented operations involving data transferred or stored in computer systems. These operations are those requiring physical manipulation of physical quantities. Usually, though not necessarily, these quantities take the form of electrical, magnetic, or optical signals capable of being stored, transferred, combined, compared, and otherwise manipulated.

Any of the operations described that form part of the presently disclosed embodiments may be useful machine operations. Various embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines employing one or more processors coupled to one or more computer readable media, described below, can be used with computer programs written in accordance with the teachings herein, or it may be more convenient to construct a more specialized apparatus to perform the required operations.

The procedures, processes, and/or modules described herein may be implemented in hardware, software, embodied as a computer-readable medium having program instructions, firmware, or a combination thereof. For example, the functions described herein may be performed by a processor executing program instructions out of a memory or other storage device.

The foregoing description has been directed to particular embodiments. However, other variations and modifications may be made to the described embodiments, with the attainment of some or all of their advantages. It will be further appreciated by those of ordinary skill in the art that modifications to the above-described systems and methods may be made without departing from the concepts disclosed herein. Accordingly, the invention should not be viewed as limited by the disclosed embodiments. Furthermore, various features of the described embodiments may be used without the corresponding use of other features. Thus, this description should be read as merely illustrative of various principles, and not in limitation of the invention.

Many changes in the details, materials, and arrangement of parts and steps, herein described and illustrated, can be made by those skilled in the art in light of teachings contained hereinabove. Accordingly, it will be understood that the following claims are not to be limited to the embodiments disclosed herein and can include practices other than those specifically described, and are to be interpreted as broadly as allowed under the law.

What is claimed is:

1. A combined greywater-stormwater runoff capture and re-use system having a forecast-integrated automated control system, comprising:
a storage tank having a greywater inlet, a stormwater runoff inlet, and a drawdown outlet;
a greywater collection system in fluidic communication with the greywater inlet;
a stormwater runoff collection system in fluidic communication with the stormwater runoff inlet;
a greywater bypass system, under control of the control system and in fluidic communication with the greywater collection system, for selectively routing greywater to the greywater inlet of the storage tank;
a stormwater runoff bypass system, under control of the control system and in fluidic communication with the stormwater runoff collection system, for selectively routing stormwater runoff to the stormwater runoff inlet of the storage tank;
a storage tank drawdown system, under control of the control system and in fluidic communication with the drawdown outlet of the storage tank for selectively routing liquid from the storage tank; and
the control system in electrical communication with a source of weather forecast data for receiving the weather forecast data therefrom,
wherein the control system is configured to control the selective operation of the greywater bypass system, the stormwater runoff bypass system, and the storage tank drawdown system in response to at least the weather forecast data.

2. The combined greywater-stormwater runoff capture and re-use system of claim 1, wherein each of the greywater bypass system and the stormwater runoff bypass system comprises a selectively operable valve for selectively routing liquid to either the storage tank or a respective sewer.

3. The combined greywater-stormwater runoff capture and re-use system of claim 1, wherein the storage tank further comprises an overflow outlet.

4. The combined greywater-stormwater runoff capture and re-use system of claim 1, wherein the storage tank drawdown system comprises a selectively operable valve for selectively routing liquid from the storage tank to a respective sewer.

5. The combined greywater-stormwater runoff capture and re-use system of claim 1, wherein the storage tank drawdown system comprises a selectively operable pump for selectively routing liquid from the storage tank to non-potable use.

6. The combined greywater-stormwater runoff capture and re-use system of claim 1, wherein the control system comprises at least a programmable controller, a communications interface, and one or more sensors disposed in conjunction with the storage tank for providing data indicative of a quality of liquid within the storage tank.

7. The combined greywater-stormwater runoff capture and re-use system of claim 6, wherein the communications interface enables communications between the controller and at least one of a remote source of weather forecast data and remote operating algorithm and data storage.

8. The combined greywater-stormwater runoff capture and re-use system of claim 1, wherein the control system is configured to control the selective operation of the greywater bypass system, the stormwater runoff bypass system, and the storage tank drawdown system in response to a preprogrammed operating algorithm.

9. The combined greywater-stormwater runoff capture and re-use system of claim 8, wherein the preprogrammed operating algorithm has as inputs at least one of sensor data indicative of storage tank liquid volume, storage tank liquid quality, precipitation forecast for the respective geographic area, historical data indicative of greywater and stormwater runoff generation over time, historical fluid flow in the greywater collection system, current fluid flow in the greywater collection system, historical fluid flow in the stormwater runoff collection system, current fluid flow in the stormwater runoff collection system, historical demand for non-potable use, current demand for non-potable use, capacity for non-potable use, and hydromodification best management practices for a respective stormwater runoff system.

10. The combined greywater-stormwater runoff capture and re-use system of claim 8, wherein the preprogrammed operating algorithm has as outputs at least one of control commands for the greywater bypass system, the stormwater runoff bypass system, and the storage tank drawdown system.

11. The combined greywater-stormwater runoff capture and re-use system of claim 8, wherein the preprogrammed operating algorithm comprises at least one of a greywater bypass system control module, a stormwater runoff bypass system module, a storage tank drawdown system control module, and a potable water storage tank refill control module.

12. The combined greywater-stormwater runoff capture and re-use system of claim 1, wherein one or both of the greywater collection system and the stormwater runoff collection system further comprises a fluid treatment facility to treat the respective fluid prior to the respective storage tank inlet.

13. The combined greywater-stormwater runoff capture and re-use system of claim 1, further comprising a storage tank potable water inlet, a potable water supply conduit in fluidic communication with the potable water inlet, and a selectively operable potable water valve under control of the control system for selectively introducing potable water into the storage tank.

14. A method of regulating the state of a liquid storage tank having a greywater inlet connected to a greywater collection system, a stormwater runoff inlet connected to a stormwater runoff collection system, and a drawdown outlet using a programmable controller capable of executing a preprogrammed algorithm provided thereto via a respective communications interface, the controller in communication with at least one sensor disposed in conjunction with the storage tank, the method comprising:
providing the algorithm to the controller via the communications interface and executing the algorithm by the controller;
providing weather forecast data to the controller via the communications interface;
determining, by the controller at least in part on the basis of input data from the at least one sensor, the instant free capacity of the storage tank or a forecast of the storage tank free capacity at one or more points in time in the future;
determining, by the controller at least in part on the basis of the weather forecast data, a volume of stormwater runoff forecast to be generated within the stormwater runoff collection system;
determining, by the controller, whether the forecast volume of stormwater runoff exceeds either the instant storage tank free capacity or the forecast storage tank free capacity; and
if the forecast volume of stormwater runoff exceeds the instant storage tank free capacity or the forecast storage tank free capacity, selectively actuating, by the controller, at least one of
a greywater bypass valve to route greywater to a destination other than the storage tank greywater inlet,
a stormwater runoff bypass valve to route stormwater runoff to a destination other than the storage tank stormwater runoff inlet, and
a drawdown system connected to the drawdown outlet to route storage tank liquid from the drawdown outlet.

15. The method of claim 14, further comprising:
determining, by the controller at least in part on the basis of input data from the at least one sensor, whether there exists free capacity within the storage tank; and
if there is not free capacity within the storage tank, selectively actuating, by the controller, at least one of
the greywater bypass valve to route any new greywater to a destination other than the storage tank greywater inlet,
the stormwater runoff bypass valve to route any new stormwater runoff to a destination other than the storage tank stormwater runoff inlet, and
the drawdown system to route storage tank liquid from the drawdown outlet.

16. The method of claim 14, wherein the drawdown system comprises a drawdown valve, and selective actuation of the drawdown system causes actuation of the drawdown valve, releasing liquid from the storage tank to an interconnected sewer.

17. The method of claim 14, wherein the drawdown system comprises a drawdown pump, and selective actuation of the drawdown system causes liquid from the storage tank to be pumped for non-potable use.

18. The method of claim 14, further comprising:
determining, by the controller at least in part on the basis of input data from the at least one sensor, a quality of liquid within the storage tank;
comparing, by the controller, the determined storage tank liquid quality to one or more predetermined threshold values; and
selectively actuating the drawdown system, by the controller, on the basis of the comparison of the determined storage tank liquid quality to the one or more predetermined threshold values.

19. The method of claim 14, further comprising:
providing greywater generation forecast data to the controller via the communications interface;
determining, by the controller at least in part on the basis of the greywater generation forecast data, a volume of greywater forecast to be generated within the greywater collection system;
determining, by the controller, whether the forecast volume of greywater exceeds either the instant storage tank free capacity or the forecast storage tank free capacity; and
if the forecast volume of greywater exceeds the instant storage tank free capacity or the forecast storage tank free capacity, selectively actuating, by the controller, at least one of
the greywater bypass valve to route greywater to a destination other than the storage tank greywater inlet,
the stormwater runoff bypass valve to route stormwater runoff to a destination other than the storage tank stormwater runoff inlet, and
the drawdown system to route storage tank liquid from the drawdown outlet.
